(19) United States
(12) Patent Application Publication
(10) Pub. No.: US 2025/0257733 A1
(43) Pub. Date: Aug. 14, 2025

(54) LOW EMISSION COMPRESSION STATION WITHOUT DEDICATED POWER GENERATION ISLAND

(71) Applicant: Nuovo Pignone Tecnologie - S.r.l., Florence (IT)

(72) Inventors: Marco SANTINI, Florence, Firenze (IT); Marco BALDINI, Florence, Firenze (IT); Andrea INTIERI, Florence, Firenze (IT)

(21) Appl. No.: 18/859,826

(22) PCT Filed: Apr. 25, 2023
(86) PCT No.: PCT/EP2023/025191

§ 371 Date: Oct. 24, 2024

(30) Foreign Application Priority Data
Apr. 29, 2022 (IT) 102022000008633

(51) Int. Cl. F04D 25/06; F01D 15/10; F04D 25/16

(52) U.S. Cl. CPC F04D 25/0673; F01D 15/10; F04D 25/16; F05D 2220/76

(57) ABSTRACT

A low emission compression station comprising one or more compressors, each compressor being coupled with an electric machine, the electric machine being coupled with at least one mechanical drive gas turbine and/or at least one fuel cell, wherein the electric machine and/or the mechanical drive gas turbines and/or the fuel cells are sized to comply with both process needs and electric loads and are controlled by a supervision system. In case electric machines are coupled with mechanical drive gas turbines, hybrid gas turbines can be used.

### TECHNICAL FIELD

The present disclosure concerns improvements to compressor stations, typically used in pipeline, capable of increasing the efficiency by reducing carbon emissions. In particular, but not exclusively, the disclosure concerns a compression station provided with one or more compressors coupled with electric machines, which are powered by fuel cells or mechanically driven by gas turbine systems in a such arrangement and sizing capable of achieving extreme reliability without the need of an additional power generation island dedicated to the compressor station.

### BACKGROUND ART

It is well known that natural gas is extracted from deep underground rock formations and need to be transported to the end users. When it is possible, or economically feasible, a pipeline transportation is generally used for transporting gas. To offset pressure losses during transportation, the pipelines require compression stations, which are arranged along the pipeline at regular intervals. The compressors of these compression stations must work extremely reliably with low maintenance requirements. As a consequence, compressors of compression stations for pipeline applications, as well as other rotary equipment for applications in the oil and gas industry, are often driven by gas turbines.

In addition, since the pipelines extend over long distances and compression stations can be positioned in remote locations, lacking an electric grid or, even if an electric grid is available, wherein such an electric grid is not reliable, a compression station generally comprises a dedicated power generation island, to provide power for auxiliary systems, allowing the compression station to operate separate from the electrical grid, or to operate also when the electrical grid is not operative. In particular, the power generation island comprises gas turbines and/or reciprocating engine generator drives operated exclusively to provide power to the auxiliary systems of the compression station.

A gas turbine power capability is dependent upon ambient conditions, namely air temperature, as well as other specific factors. The gas turbine power capability is inversely proportional to the ambient temperatures. In order to prevent any loss of power generation (in case of trip of the gas turbine), which could cause the halt of the compression station, the power generation island is generally designed in full redundancy, i.e. it comprises at least two gas turbine trains, a first gas turbine train and a second gas turbine train, each train being sized to be capable of independently provide the power needed by the auxiliary systems of the compression station. In case the operability of the first gas turbine train is impaired, it can be readily supplemented or even replaced by the second gas turbine train. Typically, such result is achieved by operating both gas turbine trains to run at 50% load, for readily relaying the full spinning reserve capability when needed.

This configuration, with two gas turbine trains in full redundancy, has the drawback of an accelerated turbine wear, since gas turbine trains running at 50% load operate under non-optimal conditions. Additionally, under normal operation, the efficiency of the two gas turbine trains in full redundancy is also low, the best efficiency being for endothermal machines being always obtained when they work at 100% load.

Moreover, for safety reasons, a power generation island for a compression station must be generally realized far enough from the compression station. This involves an additional cost for the relative infrastructures, having the same magnitude of the turbomachines, with the addition of the costs for the high tension electric network and relative substations.

There are available in the market the so called hybrid mechanical drive gas turbines, where an electric machine, which is connected to the electric power grid, is associated in combination with a gas turbine to drive a load, such as one or more compressors or pumps. The electric machine can operate as a motor, absorbing electric power from the electric power grid, so that it drives (or contributes to drive) the load, or as a generator, supplying excess electric power into the electric power grid.

In particular, the electric machine can be used to supplement mechanical power to the load, to maintain the overall mechanical power on the load shaft constant, when power availability of the turbine decreases, and/or to increase the total mechanical power used to drive the load. This function of the electric machine is referred to as helper mode. In the helper mode both the gas turbine and the electric machine supply to the load. In this case, the electric machine absorbs energy from the electric power grid, operating as a motor, and the gas turbine supplies energy to the load as well. Therefore, the power received by the load is the sum of the power generated by the gas turbine and by the electric machine.

When an excess mechanical power is available from the turbine, e.g., if the ambient temperature drops and consequent increase, or mechanical load required by the compressor drops, the excessive mechanical power generated by the gas turbine is converted into electric power, using the electric machine as a generator. In the generator mode, the gas turbine supplies energy to the load, and the electric machine feeds excess energy into the electric power grid. In such operating mode the power generated by the gas turbine is actually split, feeding the load and introducing energy in the electric power grid.

The electric machine can also be used to provide all the needed mechanical power to the load, when the turbine is not operating. This function of the electric machine is referred to as full electric mode. In the full electric mode, the gas turbine can be disconnected, and can be even shut down, might thus not work at all, while the electric machine drives the load, thus absorbing energy from the electric power grid, so that the electric machine operates as a motor. In this configuration, a clutch can be used for transforming the train system in a zero emission running mode.

Finally, in a fourth operation mode, called full power generation mode, the load, such as the compressor or the pump, absorbs the minimum torque, since the speed is kept at the minimum operating speed, the electric machine operates as a generator, and the gas turbine generates the power. This operating mode is usually operated whenever there is a power absorption peak requested by the electric power grid, thus the power generated by the turbine has to be transformed in electric energy and injected in the electric power grid.

However, at present, the hybrid gas turbine systems are always realized in a configuration that, in order to achieve a high degree of reliability, are always connected to the electrical grid.

Accordingly, an improved compression station capable of achieving a high degree of reliability without the need for a power generation station and/or a connection to the electric grid would be welcome in the field, since it would significantly reduce emissions and would at the same time reduce both CAPEX and OPEX. More specifically, it would be welcome a compression station, comprising a hybrid gas turbine, having an increased flexibility and reliability, and capable of operating in a full isolated mode.

Within the frame of the present invention the term coupling will be used to designate, according to the context, a mechanical, electrical of magnetic connection.

### SUMMARY

In one aspect, the subject matter disclosed herein is directed to a low emission compression station, comprising a plurality of compressors, each compressor being coupled with an electric machine, the electric machine being coupled with at least one fuel cell and/or at least one mechanical drive gas turbine together with relevant electrical machines, including a possible integration with a battery pack, wherein the fuel cell and/or the mechanical drive gas turbines are sized for spinning reserve electric and/or mechanical load management and controlled/supervised by an electrical supervision system that will interface with the digital optimizers of at least some compression station components in order to guarantee a full uninterrupted power supply to the compressor station, eliminating the need of a power generation island.

In another aspect, the subject matter disclosed herein concerns a low emission compression station wherein the compression station is integrated with components including auxiliary energy sources and energy storage devices, such as renewable sources (e.g. solar panels or wind turbines), gas storage, fuel cells.

In still another aspect, the subject matter disclosed herein concerns a low emission compression station wherein an electrical supervision system is configured to manage all the energy sources (battery, emergency, renewable sources) in order to align each other.

In yet another aspect, the subject matter disclosed herein concerns a low emission compression station wherein the electrical supervision system is configured to manage the loads shedding.

In another aspect, the subject matter disclosed herein concerns a low emission compression station lowering the required CAPEX, because of the lack of a dedicated power generation plant and lower and OPEX, because of a reduced number of unit to be the object of maintenance.

In another aspect, the subject matter disclosed herein concerns a low emission compression station lowering the required footprint because of the lack of a dedicated power generation plant, the delta footprint being available for installation of renewable sources as solar panel/wind turbine. Moreover, in case of offshore application the absence of a dedicated power generation island is beneficial not only in terms of footprint but also in terms of saving of weight for such power gen service.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a scheme of a low emission compression station according to a first embodiment of the present disclosure;

FIG. 2 illustrates a scheme of a low emission compression station according to a second embodiment of the present disclosure;

FIG. 3 illustrates a scheme of a low emission compression station according to a third embodiment of the present disclosure; and

FIG. 4 illustrates a scheme of a low emission compression station according to a fourth embodiment of the present disclosure.

### DETAILED DESCRIPTION OF EMBODIMENTS

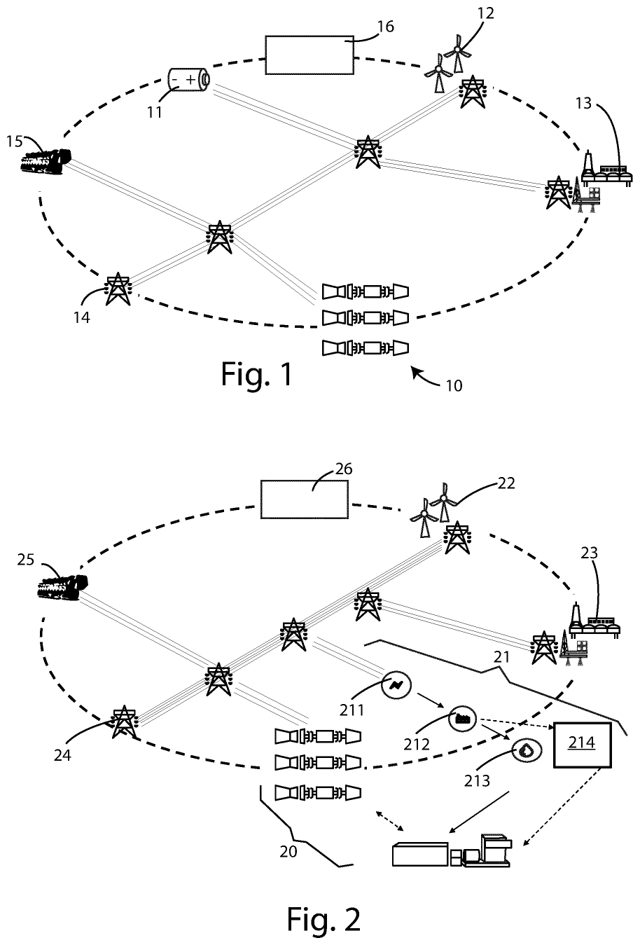

Making reference to FIG. 1, a low emission compression station according to a first embodiment of the present disclosure comprises a mechanical drive hybrid gas turbine configuration (referred to with numeral 10) in a such arrangement and in a specific method of turbomachinery sizing to eliminate the need of an additional power generation island dedicated to the compressor station.

In particular, the hybrid gas turbines 10 and the relevant electrical machines, including a possible integration with a battery pack 11, or another energy storage system, including for example a battery energy storage system (BESS), liquid air energy storage (LAES), hydrogen storage or similar, one or more other components including renewable energy system 12, an oil and gas compression station facility 13, a power grid island 14 and an emergency power generation island 15, which are sized and controlled by an electrical supervision system 16 in order to guarantee a full uninterrupted power supply to the compressor station. The configuration is particularly suitable for, but not limited to pipelines, wherein each compression station can be provided with two or three gas turbines in full redundancy for availability purpose.

The solution according to the present disclosure lowers the CAPEX of the compression station. In fact, usually, according to the prior art, a power generation island dedicated for the compressor station is composed by two power generators and a gas turbine running at a reduced load. In particular, considering that a 50% load is needed for relaying the full spinning reserve capability, then the estimated dedicated power generation island includes two gas turbines (such as for example the gas turbine model Nova LT™12 (produced by Baker and Hughes)) and all the relative infrastructure (civil works, piping, etc.) and installation. On the other hand, a hybrid implementation only includes hybrid mechanical drive gas turbines, each hybrid mechanical drive gas turbine being sized to comply with both process needs and electric loads.

The proposed solution, with hybrid mechanical drive gas turbine properly sized for spinning reserve load management also implies a higher efficiency because the hybrid mechanical drive gas turbine will run at a higher load. Additionally, by leveraging of renewable power generation, the efficiency of the station can be enhanced and so can be used to decarbonize compression: this option lowers CAPEX while leveraging compression electrification.

In particular, if a single hybrid mechanical drive gas turbine is used, according to a configuration that is not part of the present invention, then the sizing of the gas turbine must take into account that the power generation portion of the gas turbine must have the capability to cover the 100% of utilities load. In such a case, the backup power should be guaranteed by an emergency battery pack or by an emergency diesel compressor.

According to the present disclosure, in case two hybrid mechanical drive gas turbines, working in full redundancy, are used, then the main train will cover the process need and with the extra power available will cover part of the electrical load (typical 50%), while the stand-by train runs in pure power generation mode only to cover the remaining 50% of load. One of the two gas turbine is designed to provide the full electrical load, assuring the full power generation to the compressor station by means of a spinning reserve concept assuring the uninterrupted power grid supply. In case of adoption of a battery pack for spinning reserve, the stand-by unit will start as the main unit goes in trip, to provide both process load and power generation load.

In case a plurality of hybrid mechanical drive gas turbines, the concept is similar to the previous case with two gas turbines, but a higher degree of freedom for load sharing is available. Additionally, in this case the third/forth train can run also in full electric mode in case of electric power available.

In case of peak ambient temperature during the day, then the loss of power on the main compressor train can be offset by unbalancing the electric load share between the two gas turbines, from a typical 50%-50% to a different combination, up to 0-100%: namely 100% for the gas turbine that is working in pure generation mode and 0% or even negative values for the main compressor train, which, in the latter case, will absorb power (the generator absorbs power and works as a motor in helper mode configuration). In case the second gas turbine, which works in pure generation mode, has not enough power to feed the main compressor train and plant consumptions, then the battery pack and the oil and gas compression emergency system can be required to “help” the main compressor train. Also load shedding can be used for such purpose.

FIG. 2 shows a low emission compression station according to a second embodiment of the present disclosure. The system configuration comprises the hybrid mechanical drive gas turbines 20 and the relevant electrical machines, including one or more renewable energy system 22, an oil and gas compression station facility 23, an optional power grid island 24 and/or eventually an emergency power generation island 25, which are sized and controlled/supervised by an electrical supervision system 26 in order to guarantee a full uninterrupted power supply to the compressor station. In this embodiment, a hydrogen storage system 21 is present, composed of an electrolyzer 211 to produce hydrogen, together with a compressor 212 and a storage tank 213 and a connection to the pipeline 214, where hydrogen can be optionally blended with natural gas. The hydrogen from the storage tank 213 can be sent to the hybrid mechanical drive gas turbines 20, optionally in a blend including up to 100% of natural gas. The hydrogen sent to the pipeline through the connection 214 can also be used to operate the hybrid mechanical drive gas turbines 20, together with the natural gas of the pipeline. The combustion of the blend composed of hydrogen together with natural gas also contributes to reduce the production of CO₂. The hydrogen sent to the pipeline through the connection 214 can also be used as the sole feed to operate the hybrid mechanical drive gas turbines 20. As a consequence, the combustion of hydrogen minimizes the production of CO₂.

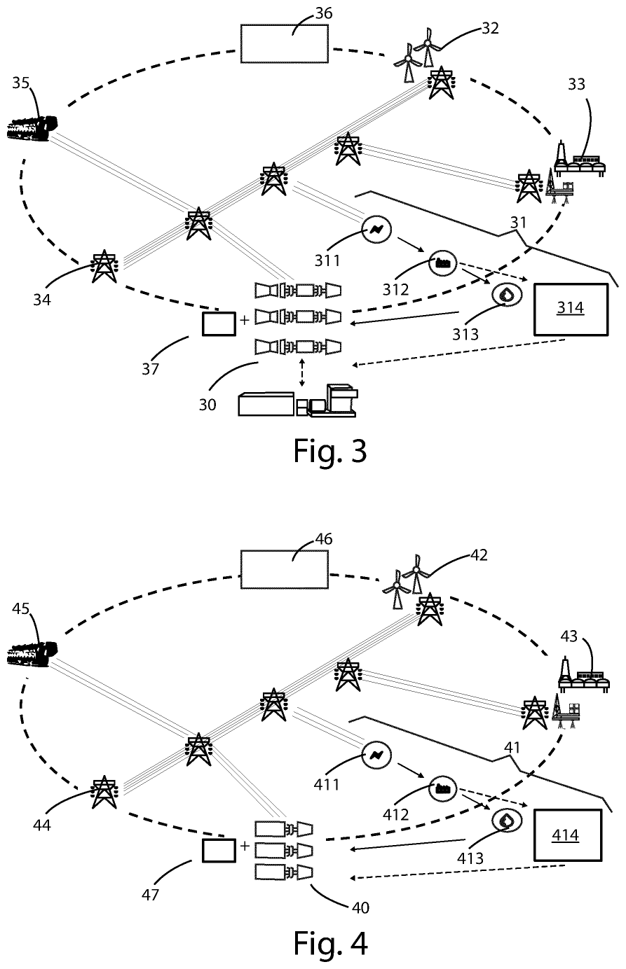

FIG. 3 shows a low emission compression station according to a third embodiment of the present disclosure. The system configuration comprises the hybrid mechanical drive gas turbines 30, connected to a fuel cell 37 (such as a solid oxide fuel cell) and the relevant electrical machines, including one or more renewable energy system 32, an oil and gas compression station facility 33, an optional power grid island 34 and/or eventually an emergency power generation island 35, which are sized and controlled/supervised by an electrical supervision system 36 in order to guarantee a full uninterrupted power supply to the compressor station. Additionally, in this embodiment, a hydrogen storage system 31 is present, having the same components already shown with reference to FIG. 2, i.e. composed of an electrolyzer 311, a compressor 312 and a storage tank 313 and a connection to the pipeline 314, where hydrogen can be blended with natural gas. The generation island 35 and the fuel cell 37 are fed with hydrogen from the hydrogen storage tank 313 and/or with hydrogen or natural gas or a mixture of hydrogen and natural gas from the pipeline 314. The combustion of the blend composed of hydrogen together with natural gas contributes to reduce the production of CO₂, while in the case that the hydrogen is used as the sole feed to operate the hybrid mechanical drive gas turbines 30 and the fuel cell 37, the combustion of hydrogen minimizes the production of CO₂.

FIG. 4 shows a low emission compression station according to a fourth embodiment of the present disclosure. The system configuration comprises the compressors 40, provided with respective electrical machines, which in turn are electrically connected to a fuel cell 47 (such as a solid oxide fuel cell). The system configuration also comprises the relevant electrical machines, including one or more renewable energy system 42, an oil and gas compression station facility 43, an optional power grid island 44 and/or eventually an emergency power generation island 45, which are sized and controlled/supervised by an electrical supervision system 46 in order to guarantee a full uninterrupted power supply to the compressor station. Additionally, in this embodiment, a hydrogen storage system 41 is present, having the same components already shown with reference to FIG. 2, i.e. composed of an electrolyzer 411, a compressor 412 and a storage tank 413 and a connection to the pipeline 414, where hydrogen can be blended with natural gas. Also according to this embodiment, the fuel cell 47 is fed with hydrogen from the hydrogen storage tank 413 and/or with hydrogen or natural gas or a mixture of hydrogen and natural gas from the pipeline 414, thus reducing or minimizing the production of CO₂.

While the invention has been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. A low emission compression station, wherein the compression station comprises one or more compressors, each compressor being coupled with an electric machine, wherein the electric machine is coupled with at least one mechanical drive gas turbine and/or at least one fuel cell, wherein the electric machine and/or the mechanical drive gas turbine and/or the fuel cell are sized to comply with both process needs and electric loads and are controlled by a supervision system.

2. The low emission compression station according to claim 1, wherein the supervision system is interfaced with the compression station components digital optimizers.

3. The low emission compression station according to claim 1, wherein the supervision system includes a digital optimizer.

4. The low emission compression station according to claim 1, wherein the compression station is integrated with energy storage devices.

5. The low emission compression station according to claim 1, wherein the compression station is integrated with a battery pack.

6. The low emission compression station according to claim 1, wherein the compression station is integrated with auxiliary energy sources.

7. The low emission compression station according to claim 6, wherein the auxiliary energy sources include renewable energy sources.

8. The low emission compression station according to claim 1, wherein the supervision system is configured to manage all the energy sources in order to align each other.

9. The low emission compression station according to claim 1, wherein the electrical supervision system is configured to manage the loads shedding.

10. The low emission compression station according to claim 1, wherein the electric machines coupled with the mechanical drive gas turbines form hybrid mechanical drive gas turbines.
